(19) United States
(12) Patent Application Publication
(10) Pub. No.: US 2005/0257363 A1
(43) Pub. Date: Nov. 24, 2005

(54) Optical diffusion plate applied for direct-type backlight module and manufacturing method thereof

(76) Inventors: Kaihsin Li, Jhongli City (TW); Jen-Huai Chang, Yongjing Shiang (TW); Jyh Horng Wang, Sansia Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/958,414

(22) Filed: Oct. 6, 2004

(30) Foreign Application Priority Data
May 21, 2004 (TW) 09311492

(51) Int. Cl. G02F 1/1335; B21B 1/46

(52) U.S. Cl. 29/527.1; 29/527.4; 29/527.2; 29/527.7

(57) ABSTRACT

An optical diffusion plate applied for a direct-type backlight module and its manufacturing method are proposed complied with the present invention. By using the extrution technique, an extruder is used to extrude an optical diffusion plate. In case the material of the optical diffusion plate is changed, the texture of the roller should also be changed so that a prism array with a vertex angle corresponding to the refractive index of the material can be formed on the diffusion plate. Thereby, via the refractive index and the angle of the prism structure, the plate having a saw structure can change the propagation directions of the diffused light beams so as to focus the light beams, reduce the loss of the light and enhance the brightness. Besides, by disposing a one- or two-dimensional structure on the optical diffusion plate, the present invention needn't use the horizontal and vertical prism sheets simultaneously.

### BACKGROUND OF THE INVENTION

1. Field of the Invention

The present invention is related to an optical diffusion plate applied for a direct-type backlight module and a manufacturing method thereof, and more particularly, to an optical diffusion plate that is made by a specific method so as to have the function of the prism sheet.

2. Description of Related Art

Due to the active research and the adoption of the large-scale manufacturing equipments, the quality of the liquid crystal displayer (LCD) improves unceasingly and the cost keeps reducing. Hence, the application field of the LCD is expanding rapidly. In order to open up new application fields, the backlight technology with the features of high brightness, low cost, low power consumption and compact size plays an important role.

In general, the backlight module of the conventional LCD usually has an edge light structure composed of a light guide plate, a diffusion film, a reflection plate and a cold cathode fluorescent tube (CCFL). The other kind of backlight module has a direct-type structure and is usually applied for the large-sized LCD. Its requirements for brightness and uniformity are higher. Hence, it uses a thicker diffusion plate to make the brightness evener. Meanwhile, the thicker diffusion plate can also provide a support function that cannot be reached by using the diffusion film.

As shown in FIG. 1, the backlight module with the direct-type structure includes a reflection sheet 10′, multiple light sources 11′, an optical diffusion plate 12′, a first prism sheet 13′, a second prism sheet 14′ and a brightness enhance film 15′. Since many thin optical plates should be combined together, it not only increases the time consumption and complexity for assembly but also the cost.

Due to the effect of the optical diffusion plate, the directionality of the light emitted from the backlight module is very bad. For the computer monitor mostly used for the front viewer, the optical efficiency is not high. Hence, if the diffusion plate is combined with a prism sheet, such as the first and second prism sheet 13′, 14′, to focus the light beams, the directionality of the output light can be increased to enhance the front brightness.

In general, the prism sheet is made of polyester or polycarbonate and its thickness is about 150˜230 μm. A prism array is formed on a surface of the prism sheet in a threadlike matrix. The spacing between the prisms is about 24˜10 μm. The vertex angles of the prisms are about 90°˜100°. Due to the structure, the prism sheet can be used to focus the light beams. Using a prism sheet with right vertex angles can make the front brightness promote about 1.6 times. Using two prism sheets with right vertex angles can make the front brightness promote more than 2 times.

The prior art uses the UV-curing technique or extrution technique to produce the prism sheet or diffusion plate. Then, the diffusion plate, prism sheet, brightness enhance film and light source module are combined together to form the backlight module. For example, U.S. Pat. Nos. 5,175,030 and 5,183,597 dispose a UV resin or a di-liquid resin on a transparent substrate via a mold to form the prism sheet; U.S. Pat. No. 5,831,774 disposes a diffusion layer on a transparent substrate and then combines it with prisms.

For the backlight module factory, the method for reducing the cost is to simplify the module structure and the design of the vertex angles should make the light beams transmitted in the front direction. Thereby, the light can be outputted from the diffusion plate uniformly and has an appropriate directionality to enhance the front brightness. Hence, the integral design of the diffusion plate not only can reduce the usage of the expensive components but also the time consumption for assembly. Meanwhile, it can enhance the brightness and reduce the cost.

Therefore, how to provide a novel optical diffusion plate applied for the direct-type backlight module and its manufacturing method to resolve the drawbacks of the prior art, which needs to combine the diffusion plate, prism sheet, brightness enhance film and light source module via assembly, so as to enhance the brightness and reduce the cost has been desired for a long time. Accordingly, in view of the research, development and practical sale experiences of the related products for many years, the inventor of the present invention sought to improve the prior art. Via inventor's professional knowledge and his research, design and case study in many ways, the inventor finally proposes an optical diffusion plate applied for the direct-type backlight module and its manufacturing method to resolve the drawback mentioned above.

### SUMMARY OF THE INVENTION

An objective of the present invention is to provide an optical diffusion plate applied for a direct-type backlight module and its manufacturing method. It uses an extruder to fuse an optical resin and an optical diffusion agent and then extrude an optical diffusion plate. Subsequently, it uses a roller to roll the optical diffusion plate. Since the surface of the roller has a texture, it can make the optical diffusion capable of diffusing light as prisms.

Another objective of the present invention is to provide an optical diffusion plate applied for a direct-type backlight module and its manufacturing method. Depending on the material of the optical diffusion plate, the texture of the roller can be designed to make the prism array of the optical diffusion plate have various angles. Due to the refractive index and the angle of the prism, the plate having a saw structure, i.e. the prism array, can change the propagation directions of the light beams to focus the diffused light beams, reduce the loss of the light and enhance the brightness.

For reaching the objectives above, the present invention provides an optical diffusion plate applied for a direct-type backlight module and its manufacturing method. The present invention discloses a method to combine an optical diffusion plate and a prism structure. It uses the extrution technique to extrude an optical diffusion plate via an extruder for uniformly diffusing the light emitted from the light source.

The primary material of the diffusion plate is a high-transparent optical resin, which is selected from Polycarbonate, PMMA, MS, ABS, PET, PETG, PS, MBS and COC. By adding an optical diffusion agent to the optical resin, the optical resin can have the capability to diffuse the light. Therein, the weight percent of the optical diffusion agent is about 1˜10 wt % and the optical diffusion agent is selected from PMMA, MS, ABS, PS and PU containing SiO₂, Mg(OH)₂, CaCO₃, BaSO₄, Al₂O₃ or TiO₂ powder.

In case the material of the diffusion plate is changed, the texture of the roller should be changed to form a prism array with a vertex angle corresponding to the refractive index of the material on the diffusion plate. Thereby, via the refractive index and the angle of the prism structure, the plate having a saw structure can change the propagation directions of the diffused light beams so as to focus the light beams, reduce the loss of the light and enhance the brightness.

The prism structure is formed by using the roller with the precise texture to roll the diffusion plate before the diffusion plate is cooled and hardened. Thereby, the present invention can provide a diffusion plate to enhance the brightness by focusing the light beams. Besides, by disposing a one- or two-dimensional structure on the optical diffusion plate, the present invention needn't use the horizontal and vertical prism sheets simultaneously.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a conventional direct-type backlight module.

FIG. 2 is a flowchart of a preferred method for manufacturing the optical diffusion plate applied for the direct-type backlight module in accordance with the present invention.

FIG. 3A is a cross-sectional view of a preferred optical diffusion plate in accordance with the present invention.

FIG. 3B is a lateral view of the preferred optical diffusion plate in accordance with the present invention.

FIG. 3C is an elevation of the preferred optical diffusion plate in accordance with the present invention.

FIG. 4 is a lateral view of another preferred optical diffusion plate in accordance with the present invention.

FIG. 5A is a lateral view of another preferred optical diffusion plate in accordance with the present invention.

FIG. 5B is a vertical view of the preferred optical diffusion plate in accordance with the present invention.

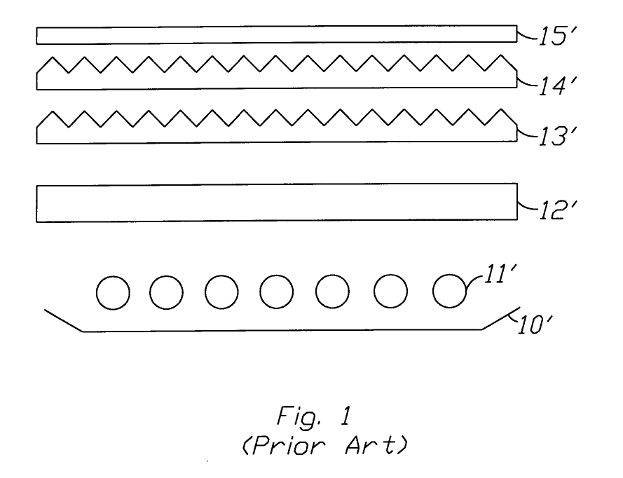

### DETAILED DESCRIPTION OF PREFERRED EMBODIMENTS

The present invention aims to resolve the drawbacks in the prior art, which needs to use a complex assembly process to combine the diffusion plate, prism sheet, brightness enhance film and light source module to produce the backlight module. The present invention uses an extruder to extrude an optical diffusion plate and uses a roller to roll the optical diffusion plate to make the surface of the optical diffusion plate have textures to focus the light beams. Depending on the material of the optical diffusion plate, the present invention can change the textures to focus the diffused light beams, reduce the loss of the light and enhance the brightness.

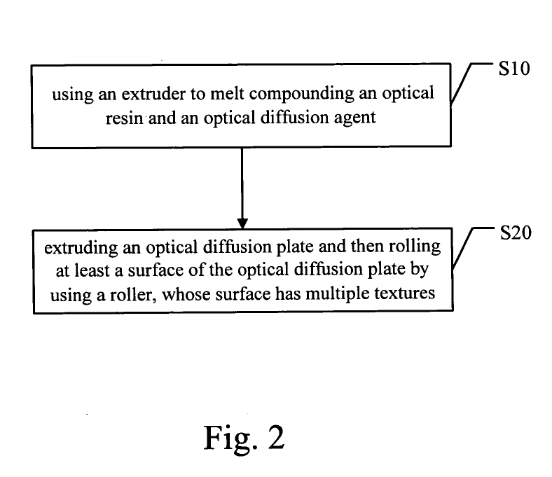

Reference is made to FIG. 2, which is a flowchart of a preferred method for manufacturing the optical diffusion plate applied for the direct-type backlight module in accordance with the present invention. As shown in the figure, the method of the present invention includes following steps:

Step S10: using an extruder to melt compounding an optical resin and an optical diffusion agent; and
Step S20: extruding an optical diffusion plate and then rolling at least a surface of the optical diffusion plate by using a roller, whose surface has multiple textures.

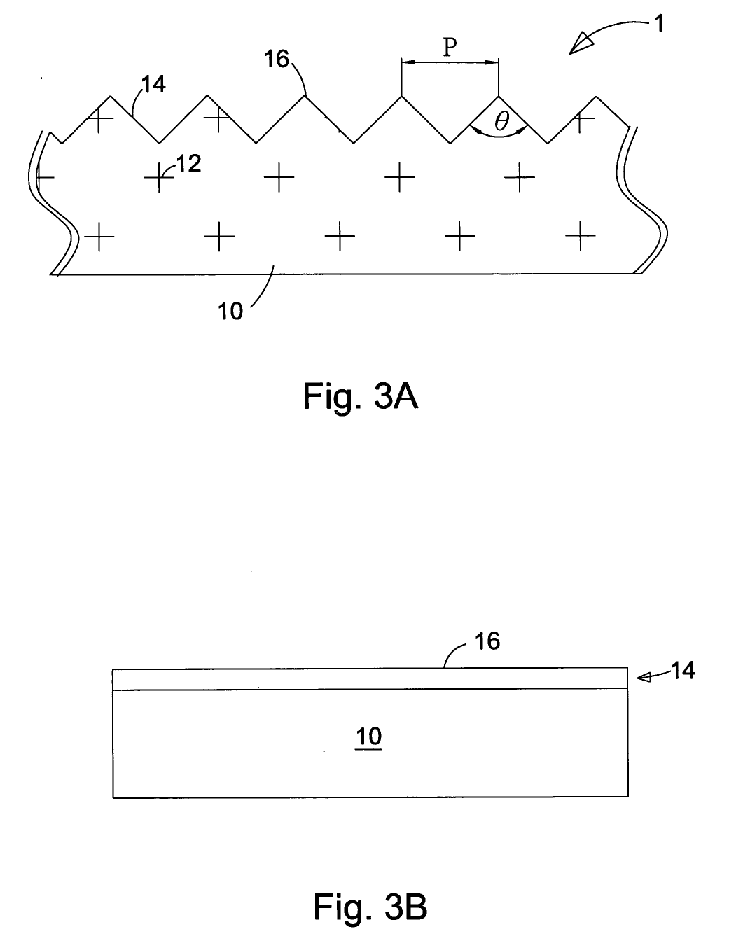

Reference is made to FIG. 3A together with FIGS. 3B and 3C. FIG. 3A shows the product made by the method mentioned above. The optical resin 10 is a combination of the materials selected from Polycarbonate, PMMA, MS, ABS, PET, PETG, PS, MBS and COC. The optical diffusion agent 12 is selected from PMMA, MS, ABS, PS and PU containing SiO₂, Mg(OH)₂, CaCO₃, BaSO₄, Al₂O₃ or TiO₂ powder. In addition, one or a combination of the materials selected from anti-static agent, UV absorber, frame retardant, antioxidant and so forth can also be added to the optical diffusion plate 1. The thickness of the optical diffusion plate 1 is about 1 mm ˜10 mm and has multiple vertex angles 16 and a texture 14. The angle θ is 80°˜100°. Further, the spacing between the vertex angles 16 is designated as P, whose value is 5˜200 μm. FIG. 3B is a front-view diagram and FIG. 3C is an elevation diagram. Further, depending on the design of the roller, the optical diffusion plate can have a one-dimensional saw structure as shown in FIG. 3C.

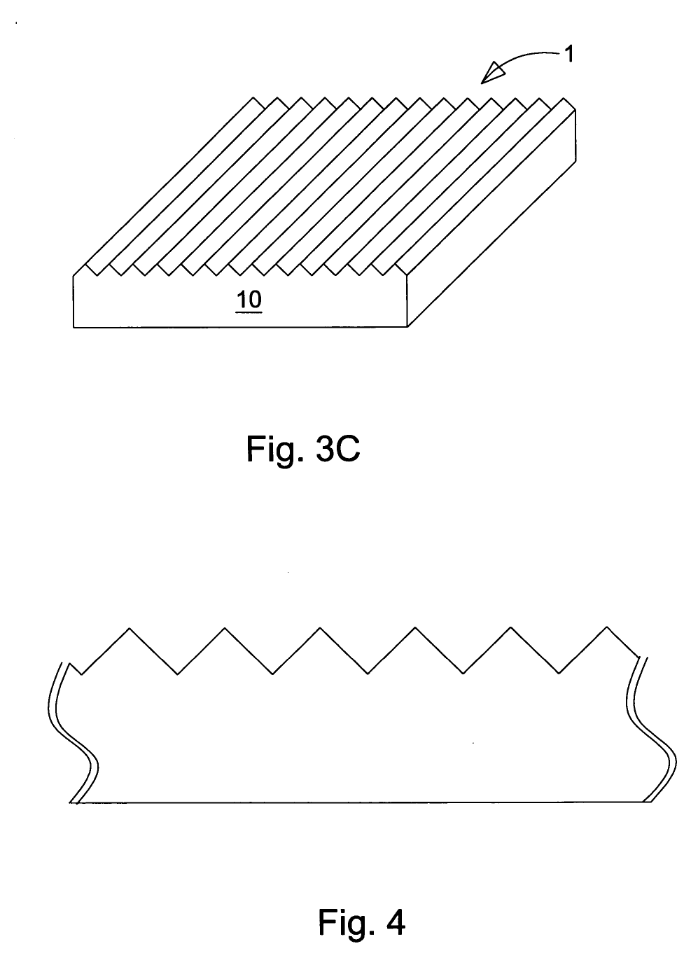

Reference is made to FIG. 4, which is a lateral view of another preferred optical diffusion plate in accordance with the present invention. In this embodiment, the front view is the same as the lateral view. Hence, this embodiment has a two-dimensional saw structure and its X-direction structure is the same as its Y-direction structure.

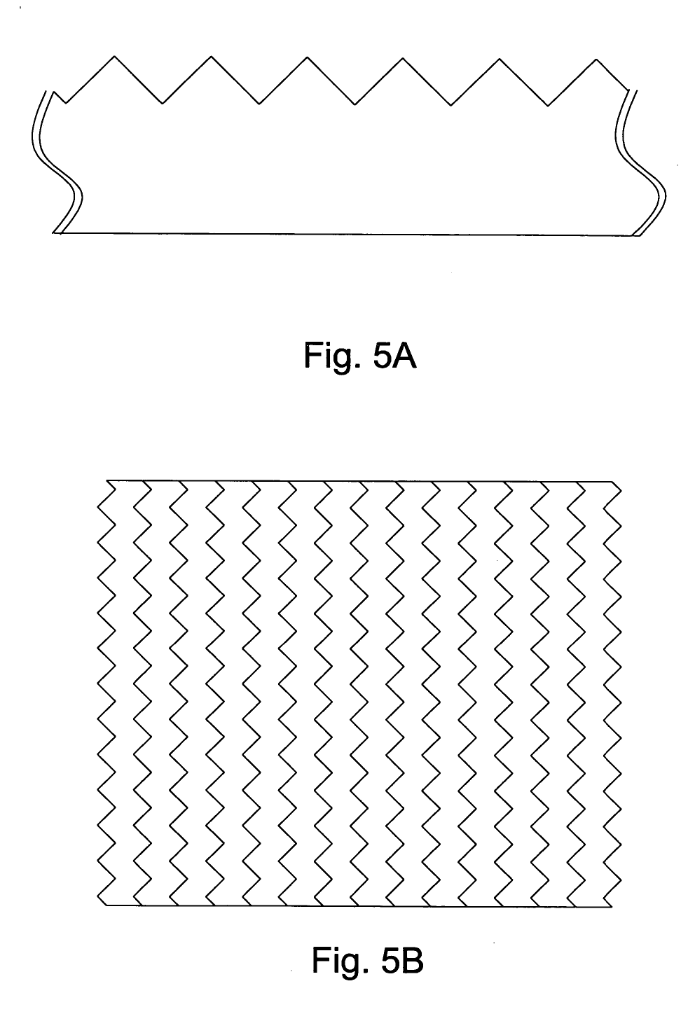

Reference is also made to FIGS. 5A and 5B, which illustrate another preferred optical diffusion plate in accordance with the present invention. Therein, FIG. 5A is a front-view diagram and FIG. 5B is a vertical view. In this embodiment, the optical diffusion plate has a saw structure in the X direction and a predetermined structure in the Y direction. The design of the Y-direction structure is to extend the length of the vertex angle lines.

### Preferred Embodiment

First, the present invention adds an optical diffusion agent (SiO₂) to the optical PC material (Bayer 3103). The present invention uses a palletizing extruder to mix the silicone powder with the PC plastic particles according to the weight percent 1%˜10%. After adding a dispersant and a plasticizer, the extruder melt these ingredients and then extrudes them to form an noodles-like material. Then, the present invention cools the extruded material via a water trough and palletizes it to produce a PC material capable of diffusing light. After adequately drying the PC material for 3˜6 hours in a temperature about 110˜120° C., the present invention extrudes the optical diffusion PC plate with a thickness of 2.0 mm in a temperature about 250˜300° C. Finally, after rolled by a roller, the optical diffusion plate of the present invention is completed. Therein, the spacing P is about 10 μm and θ is about 90°.

Summing up, the current trend tends to develop the large-sized LCD and the requirements for brightness and uniformity becomes high daily. In addition to improving the light source, improving the optical components of the backlight module is another method to reach to the requirements. The present invention provides a method for manufacturing an optical diffusion plate having high brightness. It uses the extrution technique to form a texture on a surface of the plate via a roller so as to combine the prisms with the diffusion plate. Thereby, the present invention can lower the cost and reduce the time consumption and complexity for assembly.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A method for manufacturing an optical diffusion plate applied for a direct-type backlight module, comprising:
using an extruder to melt an optical resin and an optical diffusion agent; and
rolling at least a surface of an optical diffusion plate via a roller after the optical diffusion plate is extruded;
wherein a surface of the roller has a plurality of textures.

2. The method as claimed in claim 1, wherein the optical resin is a combination of materials selected from a group consisting of Polycarbonate, PMMA, MS, ABS, PET, PETG, PS, MBS and COC.

3. The method as claimed in claim 1, wherein the optical diffusion agent is selected from a group consisting of PMMA, MS, ABS, PS and PU, containing SiO₂, Mg(OH)₂, CaCO₃, BaSO₄, Al₂O₃ or TiO₂ powder.

4. The method as claimed in claim 1, wherein the optical diffusion plate further comprises one or a combination of materials selected from a group consisting of anti-static agent, UV absorber, frame retardant, antioxidant.

5. The method as claimed in claim 1, wherein the optical diffusion plate has a thickness of 1 mm˜10 mm.

6. The method as claimed in claim 1, wherein the optical diffusion plate has a plurality of vertex angles.

7. The method as claimed in claim 6, wherein angles of the vertex angles are 80°˜110°.

8. The method as claimed in claim 6, wherein a spacing between two of the vertex angles is 5˜200 μm.

9. The method as claimed in claim 1, wherein the optical diffusion plate is rolled by a roller to form a one-dimensional saw structure.

10. The method as claimed in claim 1, wherein the optical diffusion plate is rolled by a roller to form a two-dimensional saw structure, wherein a first structure of the two-dimensional saw structure in an X direction is the same as a second structure of the two-dimensional saw structure in a Y direction.

11. The method as claimed in claim 1, wherein the optical diffusion plate is rolled by a roller to form a saw structure in a X direction and a predetermined structure in a Y direction, wherein the predetermined structure in the Y direction is different to the saw structure in the X direction.

12. An optical diffusion plate applied for a direct-type backlight module, comprising a two-dimensional saw structure; wherein an extruder is used to melt an optical resin and an optical diffusion agent and then extrude them to form the optical diffusion plate.

13. An optical diffusion plate applied for a direct-type backlight module, comprising a saw structure in a X direction and a predetermined structure in a Y direction, wherein the predetermined structure in the Y direction is different to the saw structure in the X direction; wherein an extruder is used to melt an optical resin and an optical diffusion agent and then extrude them to form the optical diffusion plate.
